(19) United States
(12) Patent Application Publication
(10) Pub. No.: US 2026/0062521 A1
(43) Pub. Date: Mar. 5, 2026

(54) SYSTEM AND METHODS FOR PRODUCING FUNCTIONALIZED NATURAL FIBERS

(71) Applicant: Heartland Industries, Inc., Ann Arbor, MI (US)

(72) Inventors: Tim ALMOND, Gilbert, AZ (US); Jesse HENRY, Palm Bay, FL (US)

(21) Appl. No.: 19/104,558

(22) PCT Filed: Aug. 16, 2023
(86) PCT No.: PCT/US2023/072279

§ 371 Date: Feb. 18, 2025

Related U.S. Application Data
(60) Provisional application No. 63/399,081, filed on Aug. 18, 2022.

(51) Int. Cl. C08H 8/00; C08L 23/12

(52) U.S. Cl. CPC C08H 8/00; C08L 23/12; C08L 2205/16

(57) ABSTRACT

The present disclosure relates to a method of manufacturing a functionalized natural fiber product, comprising providing a lignocellulosic natural fiber, milling the natural fiber into a plurality of milled natural fiber particles, treating the plurality of milled natural fiber particles with a functionalization compound, and performing a densifying process to the plurality of milled and treated natural fiber particles, wherein a functionalized natural fiber product is produced.

### CROSS REFERENCE TO RELATED APPLICATIONS

This application claims the benefit of U.S. Provisional Application No. U.S. 63/399,081, filed Aug. 18, 2022, which is hereby incorporated by reference in its entirety.

### FIELD OF THE DISCLOSURE

The present disclosure relates to processed natural fibers that can be used as additives.

### BACKGROUND

As consumption increases with population growth, the world is turning to sustainable solutions for everyday needs in an effort to ensure the long-term viability of the planet. This means that industry leaders are looking for predictable ways to reduce their carbon footprint. In fact, the future of manufacturing and construction will demand sustainable raw materials. This is particularly evident in industries that have traditionally relied on mined and petroleum-based products, where key players are refocusing on plant-based alternatives to offset the dirty, unsafe, and unsustainable production of standard materials.

High-performance carbon-negative additives are the easiest way for large companies to reduce their carbon footprint without compromising strength, weight, or price. Manufacturing with agricultural materials, however, has been inconsistent and has often resulted in an inferior product when compared against products produced using mined or petroleum-based materials.

Moreover, even if a boutique manufacturing operation can reliably generate a quality product, barriers exist to readily incorporating plant-based materials into finished products at scale, whether those plant-based materials are fully plant-based or a biocomposite. Manufacturers are looking to create a product that utilizes plant-based materials as fillers to reduce costs and carbon footprint without compromising the required functional properties. For one, agricultural goods are typically not used in industrial applications. Therefore, while producers and consumers may be familiar with agricultural goods in the produce aisle of the supermarket, they often lack the engineering skills and educational foundation to truly integrate plant-based materials into finished products.

Notably, incorporation of these new materials into workflows often require a retooling of the equipment used to manufacture the materials and the finished product due to the inherent differences between plant-based materials and standard materials (such as mined or petroleum-based materials). This retooling of the equipment increases costs associated with transitioning to plant-based materials and can be a major barrier to entry.

Accordingly, in order to realize the transition to plant-based materials (or biocomposites), systems and methods that facilitate the incorporation of plant-based materials in manufacturing and construction processes are needed.

### BRIEF SUMMARY

According to an embodiment, the present disclosure relates to a method of manufacturing a functionalized natural fiber product, comprising providing a lignocellulosic natural fiber, milling the natural fiber into a plurality of milled natural fiber particles, treating the plurality of milled natural fiber particles with a functionalization compound, and performing a densifying process to the plurality of milled and treated natural fiber particles, wherein a functionalized natural fiber product is produced, wherein the lignocellulosic natural fiber is from one or more of European hemp farmers, Chinese hemp farmers, and North American hemp farmers, the lignocellulosic natural fiber is from the genus Cannabis, the lignocellulosic natural fiber is hemp, milling comprises utilizing at least one mill member selected from the group consisting of hammer, ball, roller, pin, jet, and media, the milled natural fiber particles have an average size in the range of 10 mm to 1 nm, the milled natural fiber particles have an average size in the range of 6 mm to 10 microns, treating comprises utilizing a sprayer and/or submersion bath, treating comprises utilizing a sprayer, treating comprises utilizing a powder sprayer, treating comprises utilizing a liquid sprayer, the functionalization compound comprises at least one selected from the group consisting of maleic anhydride, stearic acid, graphene, acetylation, isocyanatoethyl methacrylate, dibutyltin dilaurate, calcium stearate, ethyl-bi-stearamide wax, sodium hydroxide, alkali, silane, unsaturated polyester-methyl ethyl ketone peroxide, and acrylonitrile, the functionalization compound comprises at least one member selected from the group consisting of foaming agents, impact modifiers, ultraviolet stabilizers, slip agents, plasticizers, flame retardants, sizing agents, compatibilizers, coupling agents, and dispersion agents, the densifying process comprises pelletizing, the functionalized natural fiber product comprises a plurality of milled, treated, and pelletized natural fiber particles with an average size in the range of 100 mm to 1 nm, the functionalized natural fiber product comprises a plurality of milled, treated, and pelletized natural fiber particles, wherein each particle within said plurality has an average size that is between 1 nm and 10 mm in size, the functionalized natural fiber product comprises a plurality of milled, treated, and pelletized natural fiber particles, wherein each particle within said plurality has an average moisture content that is less than about 1%, the functionalized natural fiber product comprises a plurality of milled, treated, and pelletized natural fiber particles, wherein each particle within said plurality has an average aspect ratio that is at least about 50:1, the functionalization compound is incorporated into the functionalized natural fiber product at a rate of between about 1% and about 60% of the total product, and/or the functionalized natural fiber product comprises a plurality of milled, treated, and pelletized natural fiber particles, wherein each particle within said plurality has an average size, moisture content, aspect ratio, functionalization compound incorporation rate that is within one standard deviation of 1 μm, 1%, 50:1, and 15%, respectively, and/or the densifying process comprises extruding milled and treated natural fiber particles-based sheets with a press, and extruding milled and treated natural fiber particles-based strands therefrom.

In an embodiment, the present further relates to a functionalized natural fiber-based resin based on the above functionalized natural fiber pellets.

In an embodiment, the present disclosure further relates to a functionalized natural fiber-based product comprising a functionalized natural fiber-based resin based on the above.

According to an embodiment, the present disclosure further relates to functionalized natural fiber pellets, comprising an average size of between about 1 nm and about 10 mm, between about 1% and about 60% functionalization compound, and between about 40% and about 99% milled natural fibers, wherein the milled natural fibers comprise lignocellulosic natural fibers, wherein the lignocellulosic natural fibers are from one or more of European hemp farmers, Chinese hemp farmers, and North American hemp farmers, the lignocellulosic natural fibers are from the genus Cannabis, the lignocellulosic natural fibers are hemp, the average size is an average length, the functionalization compound comprises at least one selected from the group consisting of maleic anhydride, stearic acid, graphene, acetylation, isocyanatoethyl methacrylate, dibutyltin dilaurate, calcium stearate, ethyl-bi-stearamide wax, sodium hydroxide, alkali, silane, unsaturated polyester-methyl ethyl ketone peroxide, and acrylonitrile, the functionalization compound comprises at least one member selected from the group consisting of foaming agents, impact modifiers, ultraviolet stabilizers, slip agents, plasticizers, flame retardants, sizing agents, compatibilizers, coupling agents, and dispersion agents, the functionalized natural fiber pellets comprise an average moisture content that is less than about 1%, and/or the functionalized natural fiber pellets have an average aspect ratio that is at least about 50:1.

According to an embodiment, the present disclosure further relates to functionalized natural fiber pellets, comprising an average size of about 1 mm, between about 10% and about 15% functionalization compound, and between about 85% and about 90% milled natural fibers, wherein the milled natural fibers comprise lignocellulosic natural fibers, wherein the lignocellulosic natural fibers are hemp, the average size is an average length, the functionalization compound comprises at least one selected from the group consisting of maleic anhydride, stearic acid, graphene, acetylation, isocyanatoethyl methacrylate, dibutyltin dilaurate, calcium stearate, ethyl-bi-stearamide wax, sodium hydroxide, alkali, silane, unsaturated polyester-methyl ethyl ketone peroxide, and acrylonitrile, and/or the functionalization compound comprises at least one member selected from the group consisting of foaming agents, impact modifiers, ultraviolet stabilizers, slip agents, plasticizers, flame retardants, sizing agents, compatibilizers, coupling agents, and dispersion agents.

According to an embodiment, the present disclosure further relates to functionalized a functionalized natural fiber-based resin, comprising between about 1% and about 50% functionalized natural fiber pellets, and between about 50% and about 99% plastic material, wherein the functionalized natural fiber pellets comprise lignocellulosic natural fibers, wherein the lignocellulosic natural fibers are from one or more of European hemp farmers, Chinese hemp farmers, and North American hemp farmers, the lignocellulosic natural fibers are from the genus Cannabis, the lignocellulosic natural fibers are hemp, functionalized natural fiber pellets are functionalized with a functionalization compound comprising at least one selected from the group consisting of maleic anhydride, stearic acid, graphene, acetylation, isocyanatoethyl methacrylate, dibutyltin dilaurate, calcium stearate, ethyl-bi-stearamide wax, sodium hydroxide, alkali, silane, unsaturated polyester-methyl ethyl ketone peroxide, and acrylonitrile, the functionalized natural fiber pellets are functionalized with a functionalization compound comprising at least one member selected from the group consisting of foaming agents, impact modifiers, ultraviolet stabilizers, slip agents, plasticizers, flame retardants, sizing agents, compatibilizers, coupling agents, and dispersion agents, the resin further comprising additives, and/or wherein the plastic material comprises one or more of polyethylene, polyethylene terephthalate, polypropylene, polyvinyl chloride, acrylonitrile butadiene styrene, polyesters, vinyl esters, polylactic acid, polyhydroxyalkanoate, polyhydroxybutyrate, and polyvinyl butyral.

### BRIEF DESCRIPTION OF THE SEVERAL VIEWS OF THE DRAWINGS

FIG. 1 is a schematic of natural fibers that may be used in the systems and methods of the present disclosure.

FIG. 2 is a flow diagram of a method of producing a lignocellulosic-based plastic filler, according to exemplary embodiments.

FIG. 3 is a flow diagram of a method of producing a lignocellulosic-based plastic filler, according to exemplary embodiments.

FIG. 4A is a flow diagram of a method of producing a lignocellulosic-based plastic filler, according to exemplary embodiments.

FIG. 4B is a flow diagram of a subprocess of a method of producing a lignocellulosic-based plastic filler, according to exemplary embodiments.

FIG. 4C is a flow diagram of a subprocess of a method of producing a lignocellulosic-based plastic filler, according to exemplary embodiments.

FIG. 5 is a graphical illustration of the mechanical properties of a variety of materials fabricated from plastics and natural fibers, according to exemplary embodiments.

FIG. 6 is an illustration of a plastic container manufactured from functionalized natural fiber-based resin, according to an exemplary embodiment of the present disclosure.

### DETAILED DESCRIPTION

### Definitions

The term “a” or “an” refers to one or more of that entity, i.e. can refer to plural referents. As such, the terms “a,” “an,” “one or more,” and “at least one” are used interchangeably herein. In addition, reference to “an element” by the indefinite article “a” or “an” does not exclude the possibility that more than one of the elements is present unless the context clearly requires that there is one and only one of the elements.

Throughout this application, the term “about” is used to indicate that a value includes the inherent variation of error for the device or the method being employed to determine the value or the variation that exists among the samples being measured. Unless otherwise stated or otherwise evident from the context, the term “about” means within 10% above or below the reported numerical value (except where such number would exceed 100% of a possible value or go below 0%). When used in conjunction with a range or series of values, the term “about” applies to the endpoints of the range or each of the values enumerated in the series, unless otherwise indicated. As used in this application, the terms “about” and “approximately” are used as equivalents.

The terms “biocomposite” and “bio-composite” may be used interchangeably herein to refer to any material, product, or other item formed by a combination of at least one material and a natural fiber material. The biocomposite may refer to a resin comprising a polymer and a natural fiber. Similarly, the biocomposite may refer to a cement block comprising cement and hemp as the natural fiber. To this end, the at least one material combined with the natural fiber may include plastic materials and non-plastic materials. With respect to non-plastic materials, exemplary biocomposites include, among others, natural fiber-filled cement, natural fiber-filled rubber, natural fiber-filled paper, natural fiber-filled ceramics, natural fiber-filled concrete, natural fiber-filled wood, and natural fiber-filled asphalt.

As used herein, the phrases “average size”, “desired size”, or variations thereof refer generally to an average of a respective dimension as measured across a plurality of natural fiber particles. In one instance, the respective dimension may be a maximum dimension, measured in any direction, appreciating that each particle may be one of a variety of shapes. In two dimensions, the particles may have a substantially rectangular cross section, a substantially triangular cross section, a substantially circular cross section, and/or other geometric cross section. In three dimensions, the particles may be substantially cylindrical, substantially conical, substantially spherical, substantially cuboidal, substantially tetrahedral, and/or substantially cubical. Of course, in either two dimensions and/or three dimensions, the shapes of the natural fiber particles may not be classified into a particle geometric class and may instead be randomly shaped by the processing steps described herein.

Although plastics are derived from petroleum, it is no secret that industries are moving toward a more sustainable future. The era of toxic fillers and reinforcement agents is coming to an end. The manufacturing companies that rely on plastic as a raw material see an opportunity to lower their carbon footprint while leading the transition toward sustainable products. To this end, in the coming years, manufacturers that utilize plastics will look to integrate bio-based raw materials, like natural fibers, into their processes to begin transitioning their supply chain toward customers' demands for more sustainable end products.

In order to leverage bio-based materials, manufacturers must have, among other things, a reliable supply chain that allows natural fibers and the like to be consistently embedded into various products manufacturers are already producing. Thus, if manufacturers are going to switch to bio-based materials, they need to first focus on bio continuity. Bio continuity is the ability to create the same bio-based raw materials time and again with 100% certainty (much in the same way lumber is reliably produced and milled to standard dimensions). To achieve bio continuity, three main variables must be controlled in order to permit standardization of bio-based materials: (1) size; (2) moisture content; and (3) surface area. If these three variables are properly controlled, then manufacturers can ensure that their bio-based raw materials perform to expectations each use. Regarding size, every manufacturer needs to understand the size of the materials they currently use, and the optimal size of the bio-based materials they're looking to adopt. It is common knowledge that the size of a bio-based material determines its tensile strength and modulus strength. The format of the material is what will determine the weight and cost reduction in each product. A material that is too big or too small creates a bottleneck in industry-standard manufacturing practices. Regarding moisture, when bio-based materials are mixed with other types of materials, there can be a problem with moisture content. Something farmed in Michigan might have 20% moisture, but that same crop in Montana might only have 5% moisture content. It is crucial that all bio-based materials have under 5% moisture content before they are mixed with other materials. If there is more than 5% moisture content, then there can be adverse effects to the compounded material or end product. Regarding surface area, traditional milling equipment can create, in the case of natural fibers, fibers that have frayed edges. These frayed edges are created because of friction that creates heat. This heat will sear the edge of the fibers. Ultimately, this destroys the structural integrity of the material and can reduce or eliminate the performance benefits found in some bio-based materials. Equipment that can create the highest surface areas allows bio-based raw materials to better blend with other materials. High surface area is one of the keys that chemists and mechanical engineers are looking for when assessing the long-term capabilities of raw materials. This will improve the ability of a bio-based material to bond with other materials.

Even with a bio continuous raw material, however, manufacturers and suppliers must still consider equipment capabilities or limitations that may hinder the uptake of bio-based raw materials into product manufacturing. To improve industry adoption of bio-based raw materials, it will be essential to eliminate the need for retooling throughout the supply chain. This includes ensuring that farmers, plastic compounders, plastic converters, and brands do not need any equipment changes in order to grow or use engineered natural fibers (i.e., bio-based raw materials). For instance, using traditional means, it may be difficult to integrate natural fibers with plastic compounding equipment at high natural fiber load rates. To achieve such load rates, manufacturers may resort to adding “crammers” to the workflow in order to permit physical loading of the natural fibers above even a 10% load rate. However, it is not efficient or practical for every manufacturer to introduce a “crammer” into their workflow. Such a limitation is addressed by the present disclosure.

To this end, the present disclosure provides systems and methods for producing a bio-based raw material that overcomes the above-described limitations of the current supply chain and current manufacturing operations.

According to an embodiment, the present disclosure relates to systems and methods for manufacturing natural fiber-based biocomposites. In embodiments, the present disclosure relates to systems and methods for manufacturing lignocellulosic-based biocomposites. In embodiments, the present disclosure relates to systems and methods for manufacturing lignocellulosic-based raw materials for use in biocomposites.

According to an embodiment, the present disclosure relates to a method of manufacturing a functionalized natural fiber product, comprising providing a lignocellulosic natural fiber, milling the natural fiber into a plurality of milled natural fiber particles, treating the plurality of milled natural fiber particles with a functionalization compound, and performing a densifying process to the plurality of milled and treated natural fiber particles, wherein a functionalized natural fiber product is formed. In embodiments, the methods of the present disclosure are referred to as a master-batching process.

In implementing the systems and methods described herein, the present disclosure solves three key issues associated with natural fiber-based manufacturing: (1) handling; (2) bonding; and (3) blossoming. In the case of hemp, in particular: (1) handling is improved by reducing moisture absorption problems, flammability problems, dust problems, density problems, and equipment feeding problems; (2) bonding is improved by functionalizing the material before it is blended to improve attraction between the cellulosic material and the plastic (and minimizing attraction amongst the hemp fibers), the functionalization enhancing interactions between tail ends of lignocellulosic molecules and tail ends of corresponding plastic/rubber molecules; and (3) blossoming is improved by functionalizing the material before it is blended, the functionalization permitting the hemp to disperse into the end material evenly. Further, the functionalization acts a lubricant between natural fibers, allowing them to easily separate during reheating and then bond to the finished rein and minimizing complications with clogging of plastic compounding equipment.

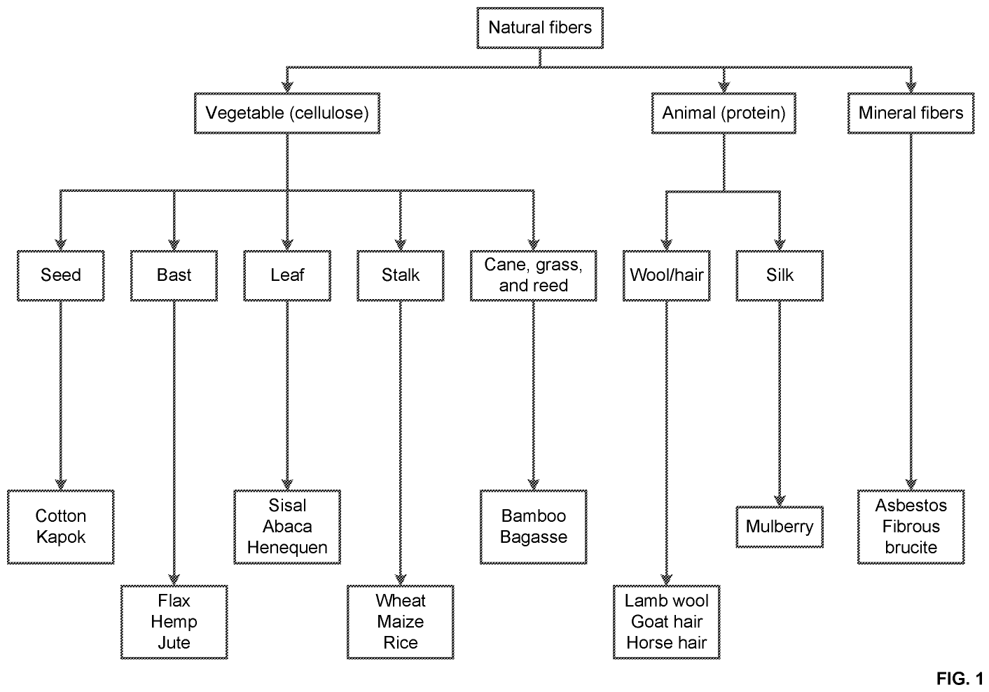

In embodiments, the natural fibers used herein may include, among others (as will be described with reference to FIG. 1), hemp, sisal, flax, bamboo, kenaf, jute, ramie, coconut, bagasse, and other lignocellulosic materials.

In embodiments, the milling is performed for size reduction and to ensure product consistency in the natural fibers. Milling can be accomplished with any type of custom or traditional milling tool (e.g., hammer mill, ball mill, roller mill, pin mill, jet mill, media mill, etc.). Milling can be performed in a one-step or multi-step process until a desired size of the particle is achieved. For instance, milling may be performed until the size of the particles is sub-micron. In an embodiment, the milling is performed by a hammer mill. In embodiments, and as will be described in more detail below, milling includes micronizing industrial hemp into natural fibers ranging between about 1 μm and about 10 mm in size, between about 10 μm and about 6 mm in size, and/or between about 10 μm and about 1 mm in size, resulting in even morphology throughout the particles.

In embodiments, treating the plurality of milled natural fiber particles with a functionalization compound includes covering the particles in organic compounds and/or inorganic compounds and improves performance characteristics through chemical reactions with the lignocellulosic fibers. In embodiments, the treating the plurality of milled natural fiber particles, which may be referred to herein as a pretreatment, can include wetting the milled natural fiber particles by spraying the functionalization compound by liquid dispersion and/or powder dispersion. In embodiments, the treating the plurality of milled natural fiber particles can be performed by a bath wetting process, or submersion process, and the milled natural fiber particles are pulled out of the bath comprising the functionalization compound and then passed to the densification process.

In embodiments, the functionalization compound can comprise different types of pretreatments, such as chemicals, solvents, enzymes, microbes, and/or other natural and synthetic materials. For instance, the pretreatment may be one or more of maleic anhydride, stearic acid, graphene, acetylation, isocyanatoethyl methacrylate, dibutyltin dilaurate, calcium stearate, ethyl-bi-stearamide wax, sodium hydroxide, alkali, silane, unsaturated polyester-methyl ethyl ketone peroxide, and acrylonitrile. In embodiments, the functionalization compound comprises additives such as foaming agents, impact modifiers, ultraviolet stabilizers, slip agents, plasticizers, flame retardants, sizing agents, compatibilizers, coupling agents, dispersion agents, and the like.

When the treatment process includes spraying the functionalization compound onto the milled natural fiber particles, the dispersion may be achieved via a continuous feeding device. Regardless of the treatment process used, it may be controlled such that a natural fiber pellet produced via the methods described herein include the functionalization compound, or the pretreatment therein, at a rate of between about 1% and about 60% of the weight of the pellet or between about 5% and about 60% of the weight of the pellet.

Such treatment, or functionalization, by the functionalization compound improves bonding, dispersion, impact strength, tensile strength, flexor modulus, ultraviolet strength, moisture absorption, smell, and carbon impact of a resulting biocomposite.

In embodiments, the treated, milled natural fiber particles then undergo a densification process. In an example, the densification process is a pelletization process in which the treated, milled natural fiber particles are compressed to decrease the bulk density of the material. In another example, the densification process is a sheeting process or an extrusion process. When the densification process is a pelletization process, the resulting pellets are referred to as a master-batch, which is then cooled via a chilling tower or traditional cooler and made ready for storage.

Together, the above allows raw material handlers to process the product without having to dry or integrate a pressurization tool to force-feed the machines, and master-batching eliminates respiratory and flame concerns that arise with airborne powders.

Engineering natural fiber additives are mission-critical to a manufacturer's ability to use bio-based materials to lower their carbon footprint. As introduced above, and as will be described more below, the system and methods of the present disclosure allow natural fibers (like hemp) to be used as an effective additive across multiple raw material supply chains (e.g., plastic, rubber, foam, asphalt, concrete, cement, paper). For instance, though natural fiber-filled plastic is of most interest here, natural fibers can be mixed with non-plastic materials to generate natural fiber-filled cement, natural fiber-filled rubber, natural fiber-filled ceramics, natural fiber-filled concrete, natural fiber-filled paper, natural fiber-filled wood, and natural fiber-filled asphalt.

It is known that natural fibers do not easily and effectively bond to mined and petroleum-based materials. Therefore, natural fibers need to be treated (and mixed) with specific chemicals to see high-performance characteristics. The ability to densify the natural fibers after they have been treated with chemicals will determine the ability to increase the percentage of natural fibers that can be used as an additive in the raw material. Without treatment and densification, a craftsman could reasonably expect to mix natural fibers into their raw materials at only a 10% load rate. With treatment and densification, the same craftsman can reasonably expect to achieve greater than 40% by weight of natural fibers in their raw materials.

Referring now to the Drawings, FIG. 1 provides a schematic of natural fibers that may be used in embodiments of the system and methods of the present disclosure. As in FIG. 1, natural fibers can be characterized into three categories: vegetable, animal, and mineral fibers. Mineral fibers can include asbestos and fibrous brucite. Animal fibers, or protein fibers, include wool/hair (e.g., lamb wool, goat hair, horse hair) and silk (e.g., mulberry). Vegetable fibers, or cellulose-based fibers, include seed (e.g., cotton, kapok), bast (e.g., flax, hemp, jute), leaf (e.g., sisal, abaca, henequen), stalk (e.g., wheat, maize, rice), and cane, grass, and reed (e.g., bamboo, bagasse). Though any one or more of the above natural fibers above may be implemented within the system and methods of the present disclosure, and it should be appreciated that other cellulosic fibers, and other natural fibers, may be envisioned within the processes described herein, the remainder of this disclosure will be directed to cellulosic fibers or lignocellulosic fibers.

Hemp, or industrial hemp, is a botanical class of Cannabis sativa cultivars grown specifically for industrial or medicinal use. It can be used to make a wide range of products. Along with bamboo, hemp is among the fastest-growing plants on Earth. Hemp is a lignocellulosic fiber of particular interest as an additive for plastics manufacturing.

Hemp stalks comprise fibers and hurd (or shive). Hemp fibers are long, strong, and skinning strands wrapped around the core of the hemp plant and account for approximately 40% of the total plant by weight. Hemp fibers provide strength and structure during the life of the plant. Their natural tensile strength and low weight make it a rapidly renewable, environmentally-conscience substitute for cotton, wood, fiberglass, and other synthetic fibers. Hemp fiber is often used to provide performance enhancements in various types of compounds and biocomposites (as will be described herein). Hemp hurd is the inner woody core of the hemp plant, consisting of over 70% cellulose. Hurd accounts for approximately 55% of the total plant by weight. During its life, the core of the hemp plant is used to transport the nutrients the plant absorbs. These small veins of the plant give the hurd unique properties after it has been properly processed. This versatile and absorbent material provides benefits across many applications including plastics and building materials.

To this end, industrial hemp can be mixed with a variety of plastic types and used in a variety of manufacturing processes. For instance, manufacturers can utilize hemp-based materials as additives to strengthen the plastic they are already utilizing, such as polyethylene, polyethylene terephthalate (PET), polypropylene, polyvinyl chloride (PVC), acrylonitrile butadiene styrene (ABS), polyesters, vinyl esters, polylactic acid, polyhydroxyalkanoate, polyhydroxybutyrate, polyvinyl butyral, and the like. Hemp fibers reduce the weight of a polyethylene and polyethylene terephthalate, while increasing metrics like tensile strength, elastic modulus, flexural strength, and flexural modulus. Hemp fibers mixed with polypropylene have improved mechanical properties, low abrasiveness, superior energy recovery, good damping, and a high strength-to-weight ratio. Polyvinyl chloride is used in a wide range of structural material across the world. Hemp is a reinforcing material for polyvinyl chloride that will increase stiffness and plasticity while decreasing the density of the composite. ABS can utilize hemp to strength the injection molding and 3D printing of plastics. Increased mold strength streamlines production. Although bio-based poly-lactic acids (PLAs) are a long way away, hemp fibers as an additive to other polyesters has shown to increase overall strength and durability without jeopardizing weight and cost. Vinyl ester mixed with hemp showed flame retardant properties of composites as indicated by the burning tests, thermogravimetry analyses, and limited oxygen index tests. Moreover, in manufacturing user products, hemp filled resin can be molded by injection, blowing, compression, and roto molding techniques, and subjected to different types of forming, including thermoforming and vacuum forming, appreciating that sheet plastic is no different when using hemp additives. Further, in manufacturing user products, hemp filled resin can be extruded through extrusion and film extrusion techniques. Hemp is safer than glass and talc, while costing less and creating lighter end products. Additionally, as it relates to extrusion, hemp filled resin has similar or higher flow rates than traditional resin while providing better end product characteristics. Hemp is also softer than mineral fillers, reducing equipment wear and tear.

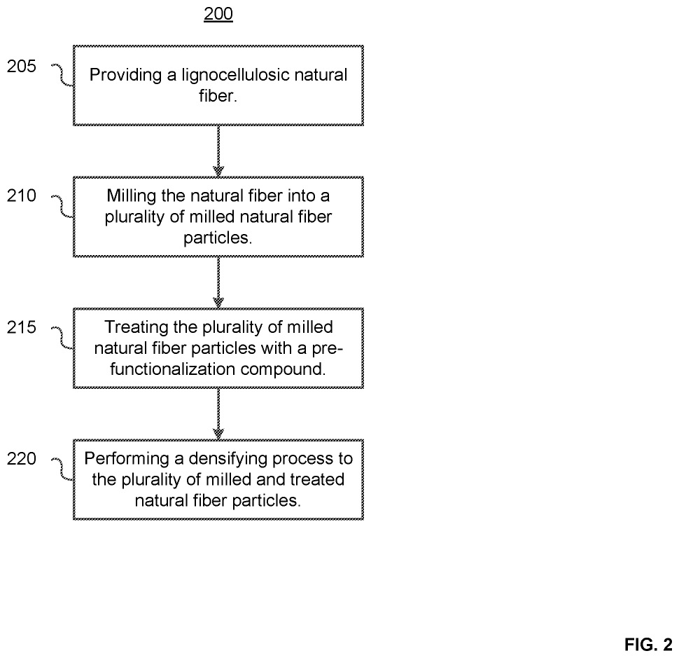

Returning now to the Figures, FIG. 2 provides a flow diagram of a method 200, according to embodiments of the present disclosure.

At step 205 of method 200, lignocellulosic natural fibers can be provided. The lignocellulosic natural fiber may be one of those provided above with reference to FIG. 1. In embodiments, the lignocellulosic natural fibers may be provided as unprocessed stalks of natural fibers. In embodiments, the lignocellulosic natural fibers may be provided as processed stalks of natural fibers, previously reduced in size to a fraction of their unprocessed length. This reduction may result in natural fiber stalks of lengths between e.g., about 20 inches to greater than about 10 feet when unbaled. Pre-processed natural fiber stalks may include unprocessed natural fiber stalks that have undergone a separation process to separate the fibers natural fiber natural fiber, unprocessed natural fiber stalks that have undergone varying levels of milling to reduce the size of, or to particulate, the natural fiber stalk and the like.

In embodiments, a moisture content of the lignocellulosic natural fibers may be approximately 5%, approximately 10%, approximately 15%, approximately 20%, and/or approximately 25% when received unprocessed from a farmer.

At step 210 of method 200, and regardless of the processing state of the received natural fiber, the received natural fiber may be milled into a plurality of milled natural fiber particles. The milling may be performed until the plurality of milled natural fiber particles are of a desired size falling within a desired size range, wherein the size may be a length, a width, a thickness, and the like of the milled natural fiber particles, depending on a particular shape of each of the plurality of milled natural fiber particles. For instance, as described in the Definitions, when a given particle is substantially cylindrical, a length of the particle may be the desired size dimension. In another instance, when a given particle has not particular shape, the maximum measured dimension is the desired size dimension. In embodiments, size can be measured by microscopy techniques, such as optical microscopy, scanning electron microscopy, and/or transmission electron microscopy, among others. In embodiments, moisture of the plurality of milled natural fiber particles may also be controlled. For instance, drying may be used in order to reduce a moisture content of unprocessed natural fiber stalks and/or a moisture content of the plurality of milled natural fiber particles. As will be described herein, drying is not required. Instead, moisture content reduction is realized alongside the processing steps outlined below. For example, an unprocessed natural fiber stalk comprising approximately 15% moisture may be reduced to less than 5% moisture after the milling steps described below, and further reduced to less than 1% after the pelletization process.

In embodiments, step 210 of method 200 includes processing the natural fiber stalks into particles. In one instance, step 210 can be performed in a single milling operation. In another instance, step 210 can be performed as sequential milling operations, beginning with a chopping operation to reduce the natural fiber stalks into rough particles followed by further milling operations to generate refined particles having desirable size dimensions. In embodiments, the chopping operation can be performed in a single operation or in multiple operations by a chopping mill. In embodiments, subsequent milling operations to further reduce the size of the particle natural fibers may be performed in a single operation or in multiple operations. When performed in a single operation, the further size reduction can be performed by a single hammer mill. When performed in multiple operations, the further size reduction can be performed by applying hammer mills of sequentially reduced “thickness” (i.e., a size to which the hammer mill reduces the size of the natural fiber particle). Sequential reduction in size can improve the consistency of the natural fiber particles and, from an efficiency perspective, increases the throughput of a particular line of equipment. In embodiments, sequential reduction is aided by the use of screens, or filters, associated with each hammer mill, the screens preventing particles that are too large or large particle aggregates, from passing to the next hammer mill.

In embodiments where milling step 210 is implemented as sequential operations, after the step of reducing the natural fiber stalks into natural fiber particles but prior to further processing, the natural fiber particle comprises an average dimension between about 1.0 centimeter and about 8.0 centimeters, between about 1.0 centimeter and about 7.0 centimeters, between about 1.0 centimeter and about 6.0 centimeters, between about 1.0 centimeter and about 5.0 centimeters, between about 1.0 centimeter and about 4.0 centimeters, between about 1.0 centimeter and about 3.0 centimeters, and/or between about 1.0 centimeter and about 2.0 centimeters.

In embodiments, the sequential operation of the milling step 210 includes, after initial size reduction via the chopping operation (or similar operation), further reducing an average dimension of the natural fiber particle so as to lie in a range between about 1 nm and about 20 mm, about 5 nm about 15 mm, between about 50 nm and about 10 mm, between about 500 nm and about 9 mm, between about 1 μm and about 8 mm, between about 5 μm and about 7 mm, between about 10 μm and about 6 mm, between about 50 μm and about 5 mm, between about 250 μm and about 4 mm, between about 500 μm and about 3 mm, and between about 750 μm and about 2 mm. In one instance, the sequential operation of the milling step 210 includes further reducing an average dimension of the particular natural fiber so as to lie in a range, between about 0.5 μm and about 300 μm, between about 0.8 μm and about 250 μm, and/or between about 0.9 μm and about 200 μm.

In embodiments, the milling step 210 is performed for size reduction and to ensure product consistency in the natural fibers. As noted above and expanded here, the milling step 210 can be accomplished with any type of traditional milling tool, including a hammer mill, a ball mill, a roller mill, a pellet mill, a pin mill, a jet mill, a media mill, and the like. Milling can be performed in a one-step or multi-step process until a desired size of the natural fiber particle is achieved.

After the milling step 210, the milled natural fiber particles can be functionalized during treatment (which may be referred to herein as wetting) step 215 of method 200. In embodiments, treating the plurality of milled natural fiber particles with a functionalization compound includes covering the particles in organic compounds and/or inorganic compounds and improves performance characteristics through chemical reactions with the lignocellulosic fibers. The treatment imparts heat resistant qualities to the lignocellulosic fibers. For instance, inclusion of the functionalization compound in the pelletized hemp permits the pelletized hemp to be heated during blending with e.g., plastic compounding materials without concern for ignition and burning of the pelletized hemp, as might conventionally be expected when using pelletized hemp that is not functionalized by the methods described herein. In embodiments, the treatment step 215, which may be referred to herein as a pretreatment, can include wetting the milled natural fiber particles by spraying the functionalization compound by liquid dispersion and/or powder dispersion. The spraying of the functionalization compound onto the milled natural fiber particles may be achieved via a continuous feeding device. In embodiments, the treatment step 215 can be performed by a bath wetting process, where the milled natural fiber particles are submersed within a bath of functionalization compound, pulled out of the bath comprising the functionalization compound, and then passed to a densification process (at step 220 of method 200).

In embodiments, the functionalization compound comprises different types of treatments (or pretreatments), such as chemicals, solvents, enzymes, microbes, and/or other natural and synthetic materials. For instance, the treatment may be one or more of maleic anhydride, stearic acid, graphene, acetylation, isocyanatoethyl methacrylate, dibutyltin dilaurate, calcium stearate, ethyl-bi-stearamide wax, sodium hydroxide, alkali, silane, unsaturated polyester-methyl ethyl ketone peroxide, and acrylonitrile. In embodiments, the functionalization compound comprises additives such as foaming agents, impact modifiers, ultraviolet stabilizers, slip agents, plasticizers, flame retardants, sizing agents, compatibilizers, coupling agents, dispersion agents, and the like.

The treatment step may be controlled such that a natural fiber pellet produced via the methods described herein include the functionalization compound, or the pretreatment therein, at a rate of between about 0.1% and about 60% of the weight of the pellet, between about 1% and about 60% of the weight of the pellet, or between about 5% and about 60% of the weight of the pellet. The composition of the natural fiber pellet can be measured by liquid chromatography, mass spectrometry, and other testing equipment. In embodiments, the composition of a functionalized natural fiber pellet may be at least about 0.1% functionalization compound by weight, about 0.2% functionalization compound by weight, about 0.25% functionalization compound by weight, about 0.3% functionalization compound by weight, about 0.4% functionalization compound by weight, about 0.5% functionalization compound by weight, about 0.6% functionalization compound by weight, about 0.7% functionalization compound by weight, about 0.8% functionalization compound by weight, about 0.9% functionalization compound by weight, 1% functionalization compound by weight, about 2% functionalization compound by weight, about 3% functionalization compound by weight, about 4% functionalization compound by weight, about 5% functionalization compound by weight, about 10% functionalization compound by weight, about 15% functionalization compound by weight, about 20% functionalized compound by weight, about 25% functionalization compound by weight, about 30% functionalization compound by weight, about 35% functionalization compound by weight, about 40% functionalization compound by weight, about 45% functionalization compound by weight, about 50% functionalization compound by weight, and/or about 55% functionalization compound by weight. In embodiments, the composition of a functionalized natural fiber pellet may be between about 10% and about 15% functionalization compound and between about 85% and about 90% natural fiber, by weight. In embodiments, the composition of a functionalized natural fiber pellet may be about 1% functionalization compound and about 99% natural fiber, by weight. In embodiments, the composition of a functionalized natural fiber pellet may be about 5% functionalization compound and about 95% natural fiber, by weight.

Such treatment, or functionalization, by the functionalization compound improves bonding, dispersion, impact strength, tensile strength, flexor modulus, ultraviolet strength, moisture absorption, smell, and carbon impact of a resulting biocomposite.

After the treatment step 215 of method 200, the treated, milled natural fiber particles then undergo a densification process at sub process 220 of method 200. In an embodiment, the densification process is a pelletization process in which the treated, milled natural fiber particles are compressed to increase the bulk density of the material. For instance, the densification process results in an at least about 2:1, about 3:1, about 4:1, about 5:1, about 6:1, about 7:1, about 8:1, about 9:1, and/or about 10:1 increase in bulk density of the material, thereby allowing increased levels of natural fiber to be included on a per unit volume bases. In another example, the densification process is a sheeting process or an extrusion process, wherein natural fiber particles may be continuously pressed (via e.g., belt-press) into a dense format that can then, after pressing, me cut into pellet-sized pieces.

In embodiments, the pelletized natural fiber particles may have a moisture content of less than about 0.1%, about 0.2%, about 0.3%, about 0.4%, about 0.5%, about 0.6%, about 0.7%, about 0.8%, about 0.9%, about 1.0%, about 2.0%, about 3%, about 4%, and/or about 5%. In embodiments, the pelletized natural fiber particles may have an aspect ratio of at least about 5:1, about 10:1, about 20:1, about 30:1, about 40:1, about 50:1, about 60:1, about 70:1, about 80:1, about 90:1, about 100:1, about 150:1, about 200:1, about 250:1, and/or about 500:1.

When the densification process is a pelletization process, the resulting pellets are referred to as a master-batch. As described below, master-batch pellets can then be cooled via a chilling tower or traditional cooler and made ready for storage, transport, or use by a compounder with a variety of e.g. plastic materials and additives to generate a resin. To this end, plastic compounders blend natural fibers with plastic alongside one or more different chemicals. This is accomplished using e.g., a ferrous continuous mixer and/or a twin screw extruder in order to disperse pellets and additives into the plastic. The plastic resin “pellet” can then be used in a variety of manufacturing methods including e.g., injection molding, to make a stronger, lighter, and more sustainable version of the same components already being fabricated, such as plastic pallets, flooring, siding, roofing, handles, carts, boards, panels, and among others.

In embodiments, the resin may comprise pelletized natural fibers at a rate of at least about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 25 about 30%, about 35%, about 40%, about 45%, and/or about 50%, by weight, and a plastic material at a rate of at least about 50%, about 55%, about 60%, about 65%, about 70%, about 75%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, and/or about 99%, by weight, the balance of the resin being comprised of additives that enhance e.g., impact resistance. For instance, the additive may comprise polyolefin elastomers and the like. In embodiments, the composition of the resin may be about 30% natural fiber pellets, about 60% plastic material, and about 10% additives. The above listings should be considered non-limiting, as the type of natural fiber, the type of functionalization compound, the type of end product, and the type of desired additives will influence the composition of the resin. Nevertheless, these factors will not impact the composition such that it departs from the spirit of the invention. After resin formation at e.g. a compounder, the resin can be used to form plastic pellets, containers, car bumpers, and the like. To this end, the plastic material integrated within the resin can be dictated by a manufacturer and be one of many plastics commonly used, such as polyethylene, polyethylene terephthalate, polypropylene, polyvinyl chloride, acrylonitrile butadiene styrene (ABS), polyesters, vinyl esters, polylactic acid, polyhydroxyalkanoate, polyhydroxybutyrate, polyvinyl butyral, and the like.

Similarly, as it relates to pelletized hemp fabricated according to the above methods, an 85% hemp pellet may comprise 30% of a resin, wherein 60% of the resin is e.g., polypropylene and the balance is additives, such as those for color fidelity, impact resistance, ultraviolet stabilization, and the like, as outlined above.

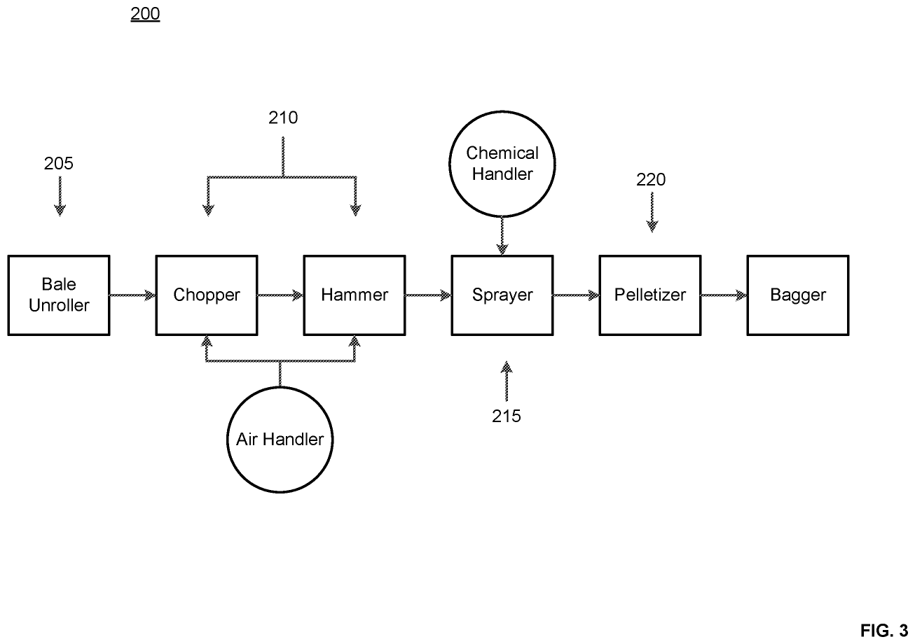

Referring now to FIG. 3, a high-level flow diagram of an exemplary system and method of the present disclosure is shown. In FIG. 3, hemp, as a representative natural fiber, is described.

From left, a bale unroller first receives a bale of unprocessed hemp stalks at step 205 of method 200 and unrolls the bale. Unprocessed hemp stalks, unlike processed hemp stalks, have not undergone a separation process to separate the fibers from the hurd and/or a size reduction process to reduce the size of the hemp stalk prior to milling.

After unbaling, and regardless of the processing state of the received hemp stalks, the received hemp stalks may be milled into a plurality of milled hemp particles at step 210. The milling may be performed until the plurality of milled hemp particles are of a desired size falling within a desired size range, wherein the size may be a length, a width, a thickness, and the like of the milled natural fiber particles. In embodiments, size can be measured by microscopy techniques, such as optical microscopy, scanning electron microscopy, and/or transmission electron microscopy, among others.

In embodiments, the milling step 210 may include, first, a chopper mill configured to roughly, in some cases sequentially, reduce the size of hemp stalks, thereby generating rough hemp particles and, second, a hammer mill configured to finely, in some cases sequentially, reduce the size of the rough hemp particles until a final desired dimension of the hemp particles is achieved. An air handler may support the milling step 210 to control humidity, temperature, and the like. In embodiments, the chopper mill, in one step or sequentially, reduces an average dimension of the hemp stalks to between about 1.0 centimeter and about 8.0 centimeters, between about 1.0 centimeter and about 7.0 centimeters, between about 1.0 centimeter and about 6.0 centimeters, between about 1.0 centimeter and about 5.0 centimeters, between about 1.0 centimeter and about 4.0 centimeters, between about 1.0 centimeter and about 3.0 centimeters, and/or between about 1.0 centimeter and about 2.0 centimeters. In embodiments, the hammer mill, in one step or sequentially, reduces an average dimension of the chopped hemp particle to lie in a range between about 1 nm and about 20 mm, about 5 nm about 15 mm, between about 50 nm and about 10 mm, between about 500 nm and about 9 mm, between about 1 μm and about 8 mm, between about 5 μm and about 7 mm, between about 10 μm and about 6 mm, between about 50 μm and about 5 mm, between about 250 μm and about 4 mm, between about 500 μm and about 3 mm, and between about 750 μm and about 2 mm. In one instance, the hammer mill, in one step or sequentially, reduces an average dimension of the chopped hemp particles to lie in a range between about 0.5 μm and about 300 μm, between about 0.8 μm and about 250 μm, and/or between about 0.9 μm and about 200 μm.

After milling, the milled particulate hemp can be treated by a sprayer at step 215. A chemical handler, which may be a reservoir for the functionalization compound as well as the mechanism by which the functionalization compound is applied to the milled particulate hemp, aids in the process. In embodiments, the functionalization compound comprises different types of treatments, such as chemicals, solvents, enzymes, microbes, and/or other natural and synthetic materials. For instance, the treatment may be one or more of maleic anhydride, stearic acid, graphene, acetylation, isocyanatoethyl methacrylate, dibutyltin dilaurate, calcium stearate, ethyl-bi-stearamide wax, sodium hydroxide, alkali, silane, unsaturated polyester-methyl ethyl ketone peroxide, and acrylonitrile. In embodiments, the functionalization compound comprises additives such as foaming agents, impact modifiers, ultraviolet stabilizers, slip agents, plasticizers, flame retardants, sizing agents, compatibilizers, coupling agents, dispersion agents, and the like. In embodiments, the sprayer at step 215 may be a continuous feeding device for liquid/powder dispersion of the functionalization compound onto the milled hemp particles. The spraying may be controlled such that a hemp pellet produced via the methods described herein includes the functionalization compound at a rate of between about 1% and about 60% of the weight of the pellet or between about 5% and about 40% of the weight of the pellet.

Following the treatment step 210, the treated, milled particulate hemp can be densified within a pelletizer during the densification step 220. In other words, during the densification step 220, the treated, milled particulate hemp can be pelletized in order to increase the density of the particles. The resulting hemp pellets can be referred to as a masterbatch.

Finally, at the completion of the method 200, the pelletized hemp can be cooled and prepared for storage by a bagger operation prior to transport and/or use by a compounder to generate a biocomposite resin.

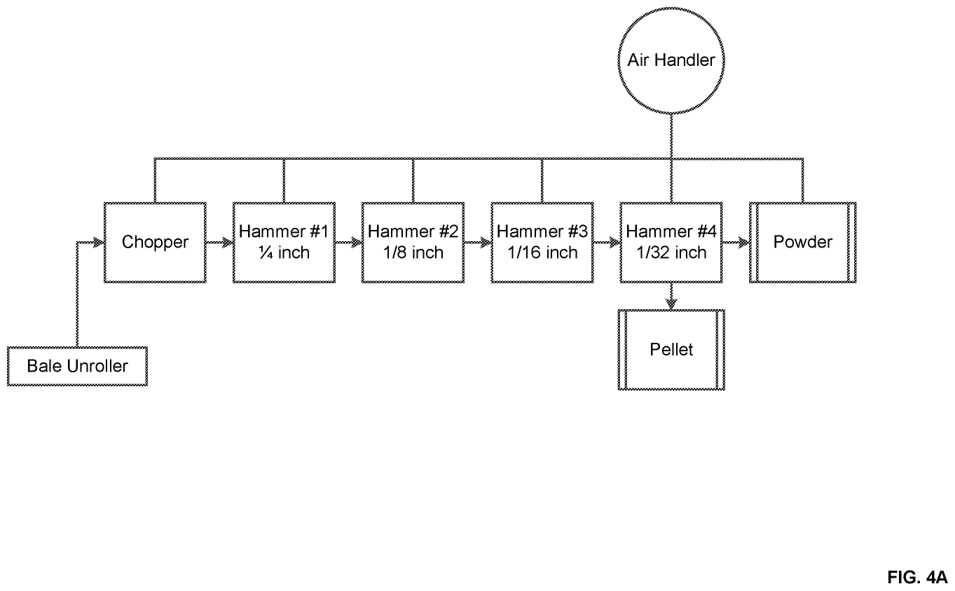

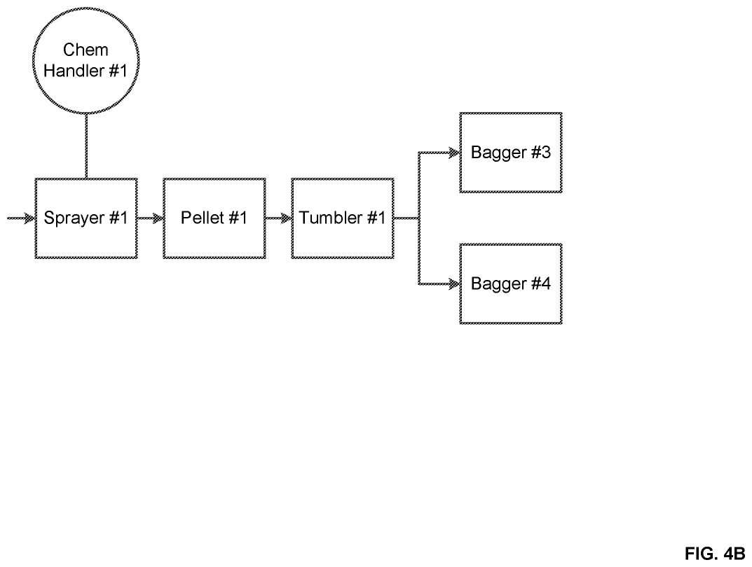

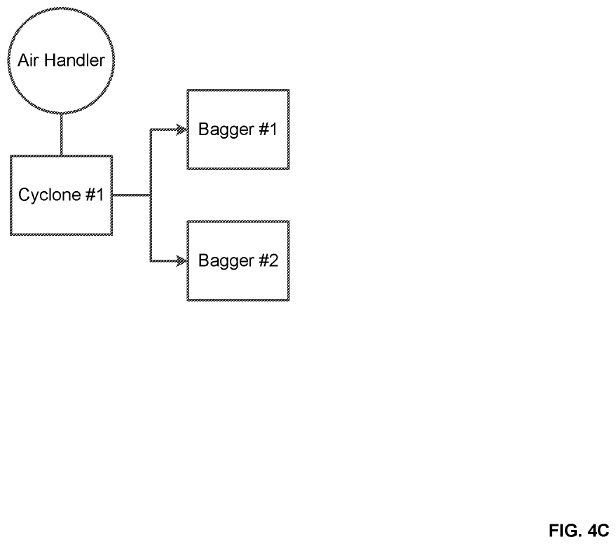

Referring now to FIG. 4A through FIG. 4C, a flow diagram of an exemplary system and method of the present disclosure is shown. In the flow diagram of FIG. 4A, which will be described with reference to hemp as the natural fiber, the milling step is performed as a sequential process. For instance, from left, after a bale unroller first receives a bale of unprocessed hemp stalks and unrolls the bale, the milling step includes, first, a chopper mill configured to reduce the hemp stalks to rough hemp particles and, second, a series of hammer mills configured to sequentially reduce the size of the rough hemp particles until a final desired dimension of the hemp particles is achieved. The hammer mill series of FIG. 4A includes four hammer mills in order: (1) a 0.25″ hammer mill; (2) a 0.125″ hammer mill; (3) a 0.0625″ hammer mill; and a (4) 0.03125″ hammer mill. An air handler may support each operation of the milling step 210. After milling, the milled hemp particles can be delivered to two separate manufacturing lines. A first line includes a powder subprocess, shown in FIG. 4C, wherein the milled hemp particles are cooled in a cyclone (“Cyclone #1), which is added by the air handler, and the cooled milled hemp particles are stored in at least one bagger, such as Bagger #1 and Bagger #2, as is the case in FIG. 4C. A second line includes a pelletizing subprocess, shown in FIG. 4B, wherein the milled hemp particles are treated during the treatment step 215 of method 200 and then pelletized during the densification step 220 of method 200. The treatment step 215 of FIG. 4B, which is aided by Chem Handler #1 (i.e., chemical handler), is indicated by Sprayer #1 and the densification step 220 of FIG. 4B is indicated by Pellet #1. Following the densification step 220, the pellets may be cooled via Tumbler #1 and then stored via at least one bagger such as Bagger #3 and Bagger #4. It can be appreciated that the cooling step of FIG. 4B and FIG. 4C may be accomplished via any suitable method of drying powder and/or pellets and should not be limited to the cyclone and tumbler of the present disclosure. Moreover, it can be appreciated that the bagging steps of FIG. 4B and FIG. 4C can be accomplished by any suitable storage mechanism for powder and/or pellets.

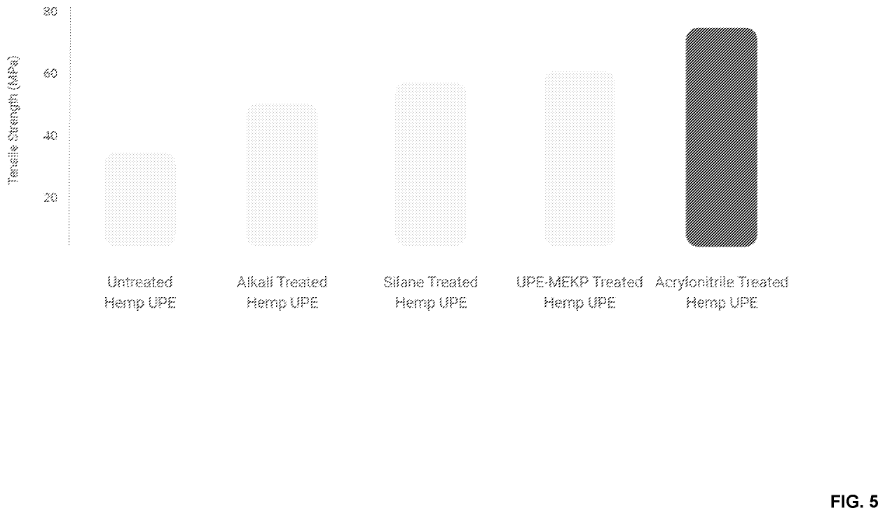

Referring now to FIG. 5, a graphical representation of mechanical performance of biocomposites demonstrates the effect of different natural fiber surface treatments on the properties of biocomposites from nonwoven industrial hemp fiber mats and unsaturated polyester resin. For instance, when compared with an untreated hemp-unsaturated polyester resin (UPE) biocomposite, each biocomposite featuring treated hemp particles (e.g., alkali treatment, silane treatment, unsaturated polyester-methyl ethyl ketone peroxide treatment, and acrylonitrile treatment) observes an improvement in bonding between the hemp and the plastic, outperforming the untreated biocomposite with regard to tensile strength.

### EXAMPLES

### Example 1: Hemp Processing

### Materials and Methods

100 kg of natural hemp fibers having a moisture content of less than 20% were obtained as a bale from an agricultural partner. Because the moisture content was below 20%, no drying step was needed. To prepare the hemp, the obtained hemp stalk, which included bast fibers and hurd, (but can include separated fiber and hurd individually). Initially, the hemp stalk is roughly processed by a chopper to obtain fiber particulates having an average particle length of 1-4 inches. After chopping, the roughly processed hemp particulates were milled by successively finer hammering to further reduce the size and moisture of the hemp particulates and improve size consistency between the hemp particulates. The milling included a ¼″ hammer, a ⅛″ hammer, a 1/16″ hammer, and a 1/32″ hammer. After milling, the milled hemp particulates were treated by a liquid and powder coating process, also referred to as a functionalization step. The coating process included spraying liquid and powder coupling agents and performance modifiers onto the milled hemp particulates. The coating process was performed at a flow rate of 10 mL/sec and for a predetermined amount of time sufficient to permit coating of at least 75% of the surface area of the milled hemp particulates. After coating, the treated and milled hemp particulates were pelletized to increase the bulk density. Pelletization was performed in a standard pellet mill by monitoring the feeding ratio to ensure the fiber-to-chemical ratio maintains at least 50% hemp. The pellets were cut to 1 mm in length and then cooled in a traditional tumbler. Once the pellets were cooled, they were bagged in a super sack for storage.

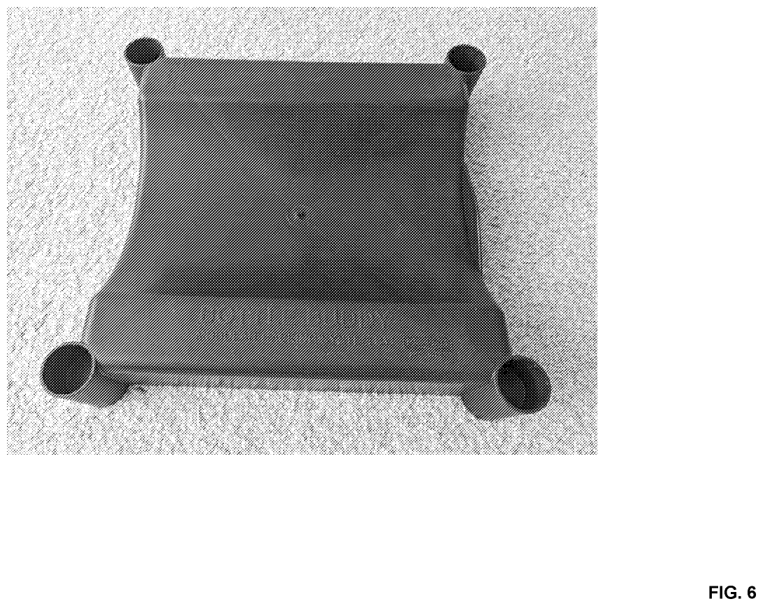

For fabrication of a fiber composite component, 1 kg of pelletized hemp was incorporated with polypropylene to generate a mixture suitable for a particular packaging component. For instance, in order to generate the fluid container holder of FIG. 6, the mixture comprised 30% pelletized hemp, 65% polypropylene, and approximately 5% of a blend of compatibilizers and performance modifiers (e.g., maleic anhydride, steric acid). Such a process is referred to as plastic compounding. The blend of compatibilizers and performance modifiers can be different based on compounder and on end user constraints. The finished mixture was shipped in a super sack to an injection molder. The finished mixture can be directly used in the injection molding process, thereby requiring no additional steps or retooling of the injection molder and can be processed in the same format as traditional resins. The packaging component (e.g. fluid container holder of FIG. 6) was then formed by injection molding.

### INCORPORATION BY REFERENCE

All references, articles, publications, patents, patent publications, and patent applications cited herein are incorporated by reference in their entireties for all purposes. However, mention of any reference, article, publication, patent, patent publication, and patent application cited herein is not, and should not be taken as an acknowledgment or any form of suggestion that they constitute valid prior art or form part of the common general knowledge in any country in the world.

### NUMBERED EMBODIMENTS OF THE INVENTION

Notwithstanding the appended claims, the disclosure sets forth the following numbered embodiments:
(1) A method of manufacturing a functionalized natural fiber product, comprising providing a lignocellulosic natural fiber, milling the natural fiber into a plurality of milled natural fiber particles, treating the plurality of milled natural fiber particles with a functionalization compound, and performing a densifying process to the plurality of milled and treated natural fiber particles, wherein a functionalized natural fiber product is produced.
(2) The method of (1), wherein the lignocellulosic natural fiber is from one or more of European hemp farmers, Chinese hemp farmers, and North American hemp farmers.
(3) The method of either (1) or (2), wherein the lignocellulosic natural fiber is from the genus Cannabis.
(4) The method of any one of (1) to (3), wherein the lignocellulosic natural fiber is hemp.
(5) The method of any one of (1) to (4), wherein milling comprises utilizing at least one mill member selected from the group consisting of hammer, ball, roller, pin, jet, and media.
(6) The method of any one of (1) to (5), wherein the milled natural fiber particles have an average size in the range of 10 mm to 1 nm.
(7) The method of any one of (1) to (6), wherein the milled natural fiber particles have an average size in the range of 6 mm to 10 microns.
(8) The method of any one of (1) to (7), wherein treating comprises utilizing a sprayer and/or submersion bath.
(9) The method of any one of (1) to (8), wherein treating comprises utilizing a sprayer.
(10) The method of any one of (1) to (9), wherein treating comprises utilizing a powder sprayer.
(11) The method of any one of (1) to (10), wherein treating comprises utilizing a liquid sprayer.
(12) The method of any one of (1) to (11), wherein the functionalization compound comprises at least one selected from the group consisting of maleic anhydride, stearic acid, graphene, acetylation, isocyanatoethyl methacrylate, dibutyltin dilaurate, calcium stearate, ethyl-bi-stearamide wax, sodium hydroxide, alkali, silane, unsaturated polyester-methyl ethyl ketone peroxide, and acrylonitrile.
(13) The method of any one of (1) to (12), wherein the functionalization compound comprises at least one member selected from the group consisting of foaming agents, impact modifiers, ultraviolet stabilizers, slip agents, plasticizers, flame retardants, sizing agents, compatibilizers, coupling agents, and dispersion agents.
(14) The method of any one of (1) to (13), wherein the densifying process comprises pelletizing.
(15) The method of any one of (1) to (14), wherein the functionalized natural fiber product comprises a plurality of milled, treated, and pelletized natural fiber particles with an average size in the range of 100 mm to 1 nm.
(16) The method of any one of (1) to (15), wherein the functionalized natural fiber product comprises a plurality of milled, treated, and pelletized natural fiber particles, wherein each particle within said plurality has an average size that is between 1 nm and 10 mm in size.
(17) The method of any one of (1) to (16), wherein the functionalized natural fiber product comprises a plurality of milled, treated, and pelletized natural fiber particles, wherein each particle within said plurality has an average moisture content that is less than about 1%.
(18) The method of any one of (1) to (17), wherein the functionalized natural fiber product comprises a plurality of milled, treated, and pelletized natural fiber particles, wherein each particle within said plurality has an average aspect ratio that is at least about 50:1.
(19) The method of any one of (1) to (18), wherein the functionalization compound is incorporated into the functionalized natural fiber product at a rate of between about 1% and about 60% of the total product.
(20) The method of any one of (1) to (19), wherein the functionalized natural fiber product comprises a plurality of milled, treated, and pelletized natural fiber particles, wherein each particle within said plurality has an average size, moisture content, aspect ratio, and/or functionalization compound incorporation rate that is within one standard deviation of 1 μm, 1%, 50:1, and 15%, respectively.
(21) The method of any one of (1) to (20), wherein the densifying process comprises extruding milled and treated natural fiber particles-based sheets with a press, and extruding milled and treated natural fiber particles-based strands therefrom.
(22) A functionalized natural fiber-based resin based on the functionalized natural fiber pellets produced by the method of any one of (1) to (21).
(23) A biocomposite comprising the functionalized natural fiber-based resin based on the functionalized natural fiber pellets produced by the method of any one of (1) to (22).
(24) Functionalized natural fiber pellets, comprising an average size of between about 1 nm and about 10 mm, between about 1% and about 60% functionalization compound, and between about 40% and about 99% milled natural fibers, wherein the milled natural fibers comprise lignocellulosic natural fibers.
(25) The functionalized natural fiber pellets of (24), wherein the lignocellulosic natural fibers are from one or more of European hemp farmers, Chinese hemp farmers, and North American hemp farmers.
(26) The functionalized natural fiber pellets of either (24) or (25), wherein the lignocellulosic natural fibers are from the genus Cannabis.
(27) The functionalized natural fiber pellets of any one of (24) to (26), wherein the lignocellulosic natural fibers are hemp.
(28) The functionalized natural fiber pellets of any one of (24) to (27), wherein the average size is an average length.
(29) The functionalized natural fiber pellets of any one of (24) to (28), wherein the functionalization compound comprises at least one selected from the group consisting of maleic anhydride, stearic acid, graphene, acetylation, isocyanatoethyl methacrylate, dibutyltin dilaurate, calcium stearate, ethyl-bi-stearamide wax, sodium hydroxide, alkali, silane, unsaturated polyester-methyl ethyl ketone peroxide, and acrylonitrile.
(30) The functionalized natural fiber pellets of any one of (24) to (29), wherein the functionalization compound comprises at least one member selected from the group consisting of foaming agents, impact modifiers, ultraviolet stabilizers, slip agents, plasticizers, flame retardants, sizing agents, compatibilizers, coupling agents, and dispersion agents.
(31) The functionalized natural fiber pellets of any one of (24) to (30), wherein the functionalized natural fiber pellets comprise an average moisture content that is less than about 1%
(32) The functionalized natural fiber pellets of any one of (24) to (31), wherein the functionalized natural fiber pellets have an average aspect ratio that is at least about 50:1.
(33) Functionalized natural fiber pellets, comprising an average size of about 1 mm, between about 10% and about 15% functionalization compound, and between about 85% and about 90% milled natural fibers, wherein the milled natural fibers comprise lignocellulosic natural fibers.
(34) The functionalized natural fiber pellets of (33), wherein the lignocellulosic natural fibers are hemp.
(35) The functionalized natural fiber pellets of either (33) or (34), wherein the average size is an average length.
(36) The functionalized natural fiber pellets of any one of (33) to (35), wherein the functionalization compound comprises at least one selected from the group consisting of maleic anhydride, stearic acid, graphene, acetylation, isocyanatoethyl methacrylate, dibutyltin dilaurate, calcium stearate, ethyl-bi-stearamide wax, sodium hydroxide, alkali, silane, unsaturated polyester-methyl ethyl ketone peroxide, and acrylonitrile.
(37) The functionalized natural fiber pellets of any one of (33) to (36), wherein the functionalization compound comprises at least one member selected from the group consisting of foaming agents, impact modifiers, ultraviolet stabilizers, slip agents, plasticizers, flame retardants, sizing agents, compatibilizers, coupling agents, and dispersion agents.
(38) A functionalized natural fiber-based resin, comprising between about 1% and about 50% functionalized natural fiber pellets, and between about 50% and about 99% plastic material, wherein the functionalized natural fiber pellets comprise lignocellulosic natural fibers.
(39) The functionalized natural fiber-based resin of (38), wherein the lignocellulosic natural fibers are from one or more of European hemp farmers, Chinese hemp farmers, and North American hemp farmers.
(40) The functionalized natural fiber-based resin of either (38) or (39), wherein the lignocellulosic natural fibers are from the genus Cannabis.
(41) The functionalized natural fiber-based resin of any one of (38) to (40), wherein the lignocellulosic natural fibers are hemp.
(42) The functionalized natural fiber-based resin of any one of (38) to (41), wherein functionalized natural fiber pellets are functionalized with a functionalization compound comprising at least one selected from the group consisting of maleic anhydride, stearic acid, graphene, acetylation, isocyanatoethyl methacrylate, dibutyltin dilaurate, calcium stearate, ethyl-bi-stearamide wax, sodium hydroxide, alkali, silane, unsaturated polyester-methyl ethyl ketone peroxide, and acrylonitrile.
(43) The functionalized natural fiber-based resin of any one of (38) to (42), wherein the functionalized natural fiber pellets are functionalized with a functionalization compound comprising at least one member selected from the group consisting of foaming agents, impact modifiers, ultraviolet stabilizers, slip agents, plasticizers, flame retardants, sizing agents, compatibilizers, coupling agents, and dispersion agents.
(44) The functionalized natural fiber-based resin of any one of (38) to (43), further comprising additives.
(45) The functionalized natural fiber-based resin of any one of (36) to (44), wherein the plastic material comprises one or more of polyethylene, polyethylene terephthalate, polypropylene, polyvinyl chloride, acrylonitrile butadiene styrene, polyesters, vinyl esters, polylactic acid, polyhydroxyalkanoate, polyhydroxybutyrate, and polyvinyl butyral.

1. A method of manufacturing a functionalized natural fiber product, comprising:
a) providing a lignocellulosic natural fiber;
b) milling the natural fiber into a plurality of milled natural fiber particles;
c) treating the plurality of milled natural fiber particles with a functionalization compound; and
d) performing a densifying process to the plurality of milled and treated natural fiber particles,
wherein a functionalized natural fiber product is produced.

2. The method of claim 1, wherein the lignocellulosic natural fiber is from one or more of European hemp farmers, Chinese hemp farmers, and North American hemp farmers.

3. The method of claim 1, wherein the lignocellulosic natural fiber is from the genus Cannabis.

4. The method of claim 1, wherein the lignocellulosic natural fiber is hemp.

5. The method of claim 1, wherein milling comprises utilizing at least one mill member selected from the group consisting of hammer, ball, roller, pin, jet, and media.

6. The method of claim 1, wherein the milled natural fiber particles have an average size in the range of 10 mm to 1 nm.

7. The method of claim 1, wherein the milled natural fiber particles have an average size in the range of 6 mm to 10 microns.

8. The method of claim 1, wherein treating comprises utilizing a sprayer and/or submersion bath.

9. The method of claim 1, wherein treating comprises utilizing a sprayer.

10. The method of claim 1, wherein treating comprises utilizing a powder sprayer.

11. The method of claim 1, wherein treating comprises utilizing a liquid sprayer.

12. The method of claim 1, wherein the functionalization compound comprises at least one selected from the group consisting of maleic anhydride, stearic acid, graphene, acetylation, isocyanatoethyl methacrylate, dibutyltin dilaurate, calcium stearate, ethyl-bi-stearamide wax, sodium hydroxide, alkali, silane, unsaturated polyester-methyl ethyl ketone peroxide, and acrylonitrile.

13. The method of claim 1, wherein the functionalization compound comprises at least one member selected from the group consisting of foaming agents, impact modifiers, ultraviolet stabilizers, slip agents, plasticizers, flame retardants, sizing agents, compatibilizers, coupling agents, and dispersion agents.

14. The method of claim 1, wherein the densifying process comprises pelletizing.

15. The method of claim 14, wherein the functionalized natural fiber product comprises a plurality of milled, treated, and pelletized natural fiber particles with an average size in the range of 100 mm to 1 nm.

16. The method of claim 14, wherein the functionalized natural fiber product comprises a plurality of milled, treated, and pelletized natural fiber particles, wherein each particle within said plurality has an average size that is between 1 nm and 10 mm in size.

17. The method of claim 14, wherein the functionalized natural fiber product comprises a plurality of milled, treated, and pelletized natural fiber particles, wherein each particle within said plurality has an average moisture content that is less than about 1%.

18. The method of claim 14, wherein the functionalized natural fiber product comprises a plurality of milled, treated, and pelletized natural fiber particles, wherein each particle within said plurality has an average aspect ratio that is at least about 50:1.

19. The method of claim 1, wherein the functionalization compound is incorporated into the functionalized natural fiber product at a rate of between about 1% and about 60% of the total product.

20. The method of claim 14, wherein the functionalized natural fiber product comprises a plurality of milled, treated, and pelletized natural fiber particles, wherein each particle within said plurality has an average size, moisture content, aspect ratio, and/or functionalization compound incorporation rate that is within one standard deviation of 1 μm, 1%, 50:1, and 15%, respectively.

21. The method of claim 1, wherein the densifying process comprises extruding milled and treated natural fiber particles-based sheets with a press and extruding milled and treated natural fiber particles-based strands therefrom.

22. A functionalized natural fiber-based resin based on the functionalized natural fiber pellets of claim 1.

23. A biocomposite comprising the functionalized natural fiber-based resin of claim 22.

24. Functionalized natural fiber pellets, comprising:
an average size of between about 1 nm and about 10 mm;
between about 1% and about 60% functionalization compound; and
between about 40% and about 99% milled natural fibers,
wherein the milled natural fibers comprise lignocellulosic natural fibers.

25. The functionalized natural fiber pellets of claim 24, wherein the lignocellulosic natural fibers are from one or more of European hemp farmers, Chinese hemp farmers, and North American hemp farmers.

26. The functionalized natural fiber pellets of claim 24, wherein the lignocellulosic natural fibers are from the genus Cannabis.

27. The functionalized natural fiber pellets of claim 24, wherein the lignocellulosic natural fibers are hemp.

28. The functionalized natural fiber pellets of claim 24, wherein the average size is an average length.

29. The functionalized natural fiber pellets of claim 24, wherein the functionalization compound comprises at least one selected from the group consisting of maleic anhydride, stearic acid, graphene, acetylation, isocyanatoethyl methacrylate, dibutyltin dilaurate, calcium stearate, ethyl-bi-stearamide wax, sodium hydroxide, alkali, silane, unsaturated polyester-methyl ethyl ketone peroxide, and acrylonitrile.

30. The functionalized natural fiber pellets of claim 24, wherein the functionalization compound comprises at least one member selected from the group consisting of foaming agents, impact modifiers, ultraviolet stabilizers, slip agents, plasticizers, flame retardants, sizing agents, compatibilizers, coupling agents, and dispersion agents.

31. The functionalized natural fiber pellets of claim 24, wherein the functionalized natural fiber pellets comprise an average moisture content that is less than about 1%.

32. The functionalized natural fiber pellets of claim 24, wherein the functionalized natural fiber pellets have an average aspect ratio that is at least about 50:1.

33. Functionalized natural fiber pellets, comprising:
an average size of about 1 mm;
between about 10% and about 15% functionalization compound; and
between about 85% and about 90% milled natural fibers,
wherein the milled natural fibers comprise lignocellulosic natural fibers.

34. The functionalized natural fiber pellets of claim 33, wherein the lignocellulosic natural fibers are hemp.

35. The functionalized natural fiber pellets of claim 33, wherein the average size is an average length.

36. The functionalized natural fiber pellets of claim 33, wherein the functionalization compound comprises at least one selected from the group consisting of maleic anhydride, stearic acid, graphene, acetylation, isocyanatoethyl methacrylate, dibutyltin dilaurate, calcium stearate, ethyl-bi-stearamide wax, sodium hydroxide, alkali, silane, unsaturated polyester-methyl ethyl ketone peroxide, and acrylonitrile.

37. The functionalized natural fiber pellets of claim 33, wherein the functionalization compound comprises at least one member selected from the group consisting of foaming agents, impact modifiers, ultraviolet stabilizers, slip agents, plasticizers, flame retardants, sizing agents, compatibilizers, coupling agents, and dispersion agents.

38. A functionalized natural fiber-based resin, comprising:
between about 1% and about 50% functionalized natural fiber pellets; and
between about 50% and about 99% plastic material,
wherein the functionalized natural fiber pellets comprise lignocellulosic natural fibers.

39. The functionalized natural fiber-based resin of claim 38, wherein the lignocellulosic natural fibers are from one or more of European hemp farmers, Chinese hemp farmers, and North American hemp farmers.

40. The functionalized natural fiber-based resin of claim 38, wherein the lignocellulosic natural fibers are from the genus Cannabis.

41. The functionalized natural fiber-based resin of claim 38, wherein the lignocellulosic natural fibers are hemp.

42. The functionalized natural fiber-based resin of claim 38, wherein functionalized natural fiber pellets are functionalized with a functionalization compound comprising at least one selected from the group consisting of maleic anhydride, stearic acid, graphene, acetylation, isocyanatoethyl methacrylate, dibutyltin dilaurate, calcium stearate, ethyl-bi-stearamide wax, sodium hydroxide, alkali, silane, unsaturated polyester-methyl ethyl ketone peroxide, and acrylonitrile.

43. The functionalized natural fiber-based resin of claim 38, wherein the functionalized natural fiber pellets are functionalized with a functionalization compound comprising at least one member selected from the group consisting of foaming agents, impact modifiers, ultraviolet stabilizers, slip agents, plasticizers, flame retardants, sizing agents, compatibilizers, coupling agents, and dispersion agents.

44. The functionalized natural fiber-based resin of claim 38, further comprising additives.

45. The functionalized natural fiber-based resin of claim 38, wherein the plastic material comprises one or more of polyethylene, polyethylene terephthalate, polypropylene, polyvinyl chloride, acrylonitrile butadiene styrene, polyesters, vinyl esters, polylactic acid, polyhydroxyalkanoate, polyhydroxybutyrate, and polyvinyl butyral.
